(19) United States
(12) Patent Application Publication
(10) Pub. No.: US 2015/0114951 A1
(43) Pub. Date: Apr. 30, 2015

(54) WALL MOUNTED ELECTRIC HEATER

(71) Applicants: TSINGHUA UNIVERSITY, Beijing (CN); HON HAI PRECISION INDUSTRY CO., LTD., New Taipei (TW)

(72) Inventors: CHEN FENG, Beijing (CN); KAI-LI JIANG, Beijing (CN); LIANG LIU, Beijing (CN); SHOU-SHAN FAN, Beijing (CN)

(21) Appl. No.: 14/565,325

(22) Filed: Dec. 9, 2014

Related U.S. Application Data
(63) Continuation of application No. 12/769,794, filed on Apr. 29, 2010.

(30) Foreign Application Priority Data
Sep. 8, 2009 (CN) 200910190174.8

(51) Int. Cl. F24D 13/02; H05B 3/14; H05B 3/26

(52) U.S. Cl. CPC F24D 13/02; H05B 3/26; H05B 3/145
USPC 219/546

(57) ABSTRACT

A wall mounted electric heater includes a substrate, a heat insulated sheet, a heating element, at least two electrodes, and an enclosure. The heat insulated sheet is disposed on a surface of the substrate. The heat insulated sheet has a geometrical surface with at least one groove or protrusion thereon. The heating element is disposed on the heat insulated sheet. The heating element includes a carbon nanotube layer structure. The at least two electrodes are electrically connected with the heating element. The enclosure fixes the substrate, the heat insulated sheet, and the heating element therein.

### CROSS-REFERENCE TO RELATED APPLICATIONS

This application is a continuation of U.S. patent application Ser. No. 12/769,794, filed on Apr. 29, 2010, entitled, “WALL MOUNTED ELECTRIC HEATER” which claims all benefits accruing under 35 U.S.C. §119 from China Patent Application No. 200910190174.8, filed on Sep. 8, 2009 in the China Intellectual Property Office. The application is also related to copending application Ser. No. 12/769,805 entitled, “ELECTRIC HEATER”, filed on Apr. 29, 2010.

### BACKGROUND

1. Technical Field

The present disclosure generally relates to wall mounted electric heaters incorporating carbon nanotubes.

2. Description of Related Art

Electric heaters are configured for generating heat from electrical energy. Wall mounted electric heaters are one kind of electric heaters. Wall mounted electric heaters are suspended on the wall when in use. Wall mounted electric heaters often have a planar structure with thin profile and large surface.

A typical wall mounted heater includes a heating element and at least two electrodes. The heating element is often made of metal such as tungsten. Metals, which have good conductivity, can generate a lot of heat even when a low voltage is applied. However, since metals have a relatively high density, the heating element made of such metals are heavy, which can cause damage to the wall.

What is needed, therefore, is a wall mounted electric heater based on carbon nanotubes that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of one embodiment of a wall mounted electric heater having a carbon nanotube layer structure.

FIG. 2 is a schematic, cross-sectional view, along a line II-II of FIG. 1.

FIG. 3 is a schematic top plan view of a heat insulated sheet having a plurality of column blind holes that can be used in the wall mounted electric heater in FIG. 1.

FIG. 4 is a schematic, cross-sectional view, along a line IV-IV of FIG. 3.

FIG. 5 is a schematic top plan view of a heat insulated sheet having a plurality of bar-shaped groves that can be used in the wall mounted electric heater in FIG. 1.

FIG. 6 is a schematic, cross-sectional view, along a line VI-VI of FIG. 5.

FIG. 7 is a schematic top plan view of a heat insulated sheet having one square groove that can be used in the wall mounted electric heater in FIG. 1.

FIG. 8 is a schematic, cross-sectional view, along a line VIII-VIII of FIG. 8.

FIG. 9 is a schematic side view of a heat insulated sheet having a plurality of hemispherical shaped protrusions that can be used in the wall mounted electric heater in FIG. 1.

FIG. 10 is a schematic side view of a heat insulated sheet having a plurality of V-shaped protrusions that can be used in the wall mounted electric heater in FIG. 1.

FIG. 11 is a Scanning Electron Microscope (SEM) image of a drawn carbon nanotube film.

FIG. 12 is an SEM image of a flocculated carbon nanotube film.

FIG. 13 is an SEM image of a pressed carbon nanotube film.

FIG. 14 is a schematic view of another embodiment of a wall mounted electric heater.

FIG. 15 is a schematic, cross-sectional view, along a line XV-XV of FIG. 14.

FIG. 16 is a schematic view of yet another embodiment of a wall mounted electric heater.

FIG. 17 is a schematic, cross-sectional view, along a line XVII-XVII of FIG. 16.

FIG. 18 is a cross-sectional side view of a wall mounted heater according to one embodiment.

FIG. 19 is a cross-sectional side view of a wall mounted heater according to another embodiment.

FIG. 20 is a cross-sectional side view of a wall mounted heater according to yet another embodiment.

FIG. 21 is a cross-sectional side view of a wall mounted heater according to still yet another embodiment.

FIG. 22 is a schematic view of one embodiment of a wall mounted electric heater.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

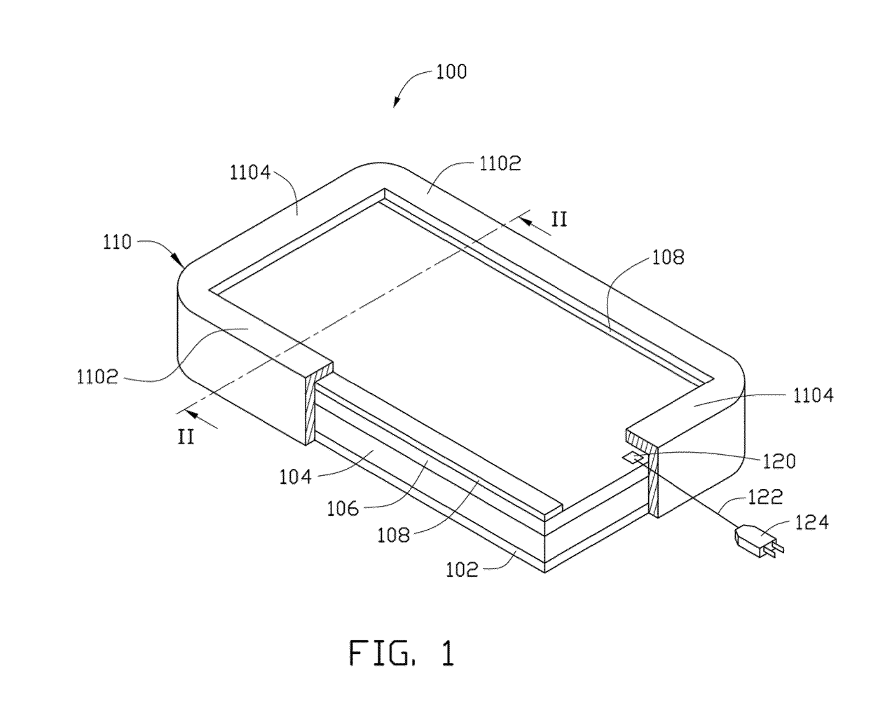

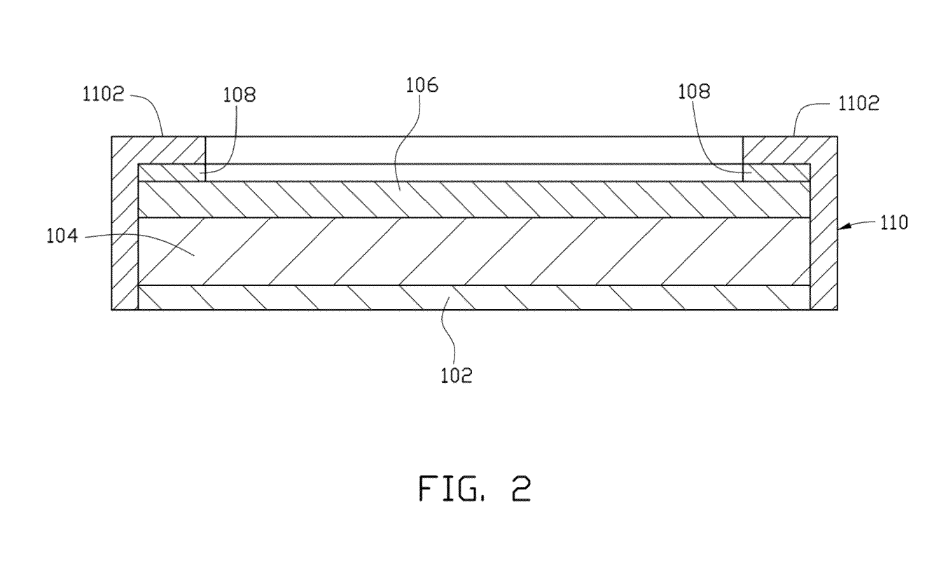

Referring to FIGS. 1 and 2, one embodiment of a wall mounted electric heater 100 includes a substrate 102, a heat insulated sheet 104, a heating element 106, at least two electrodes 108 and an enclosure 110. The heat insulated sheet 104 is disposed on a surface of the substrate 102. The heating element 106 is disposed on a surface of the heat insulated sheet 104. The two electrodes 108 are electrically connected with the heating element 106. The substrate 102, the heat insulated sheet 104 and the heating element 106 form a multilayer structure in that order. The heat insulated sheet 104 is disposed between the substrate 102 and the heating element 106. The multilayer structure comprised of the substrate 102, the heat insulated sheet 104 and the heating element 106 is fixed by the enclosure 110. The wall mounted electric heater 100 further includes a source connection 120, a source wire 122 and a source plug 124.

The substrate 102 is configured to support the heat insulated sheet 104 and the heating element 106. The substrate 102 includes a bottom surface (not labeled) and a top surface (not labeled) opposite with the first surface. The heat insulated sheet 104 is disposed on the top surface of the substrate 102. The substrate 102 can be made of flexible materials or rigid materials. The flexible materials may be plastics, resins or fibers. The rigid materials may be ceramic, glass, or quartz. The shape and size of the substrate 102 can be determined according to practical needs. For example, the substrate 102 may be square, round or triangular. In one embodiment, the substrate 102 is a square ceramic sheet about 1 millimeter (mm) thick. The first surface of the substrate 102 can contact with a wall when the wall mounted electric heater 100 is used. The substrate 102 further defines a blind hole (not shown) at the bottom surface. The wall mounted electric heater 100 can be hung on the wall via the blind hole. In another embodiment, the substrate 102 further includes an extension portion (not shown), and the extension portion includes a through hole. The wall mounted electric heater 100 can be hung on the wall via the through hole.

The heat insulated sheet 104 is made of heat insulated materials. The heat insulated sheet 104 is configured for preventing the heat produced by the heating element 106 from spreading to the wall. The heat insulated sheet 104 can define a hollow space (not shown). In another embodiment, the hollow space can be a sealed vacuum space. The heat insulated sheet 104 with sealed vacuum space has good heat insulation properties. The heat insulated sheet 104 can be made of flexible materials or rigid materials. The flexible materials may be plastics, resins or fibers. The rigid materials may be ceramic, glass, quartz, or wood. The shape and size of the heat insulated sheet 104 can be determined according to practical needs. A thickness of the heat insulated sheet 104 can be in a range from about 1 centimeter to about 10 centimeters.

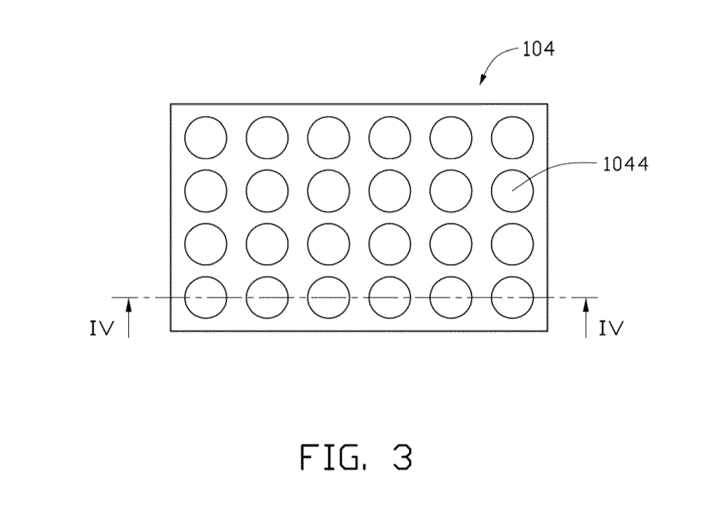

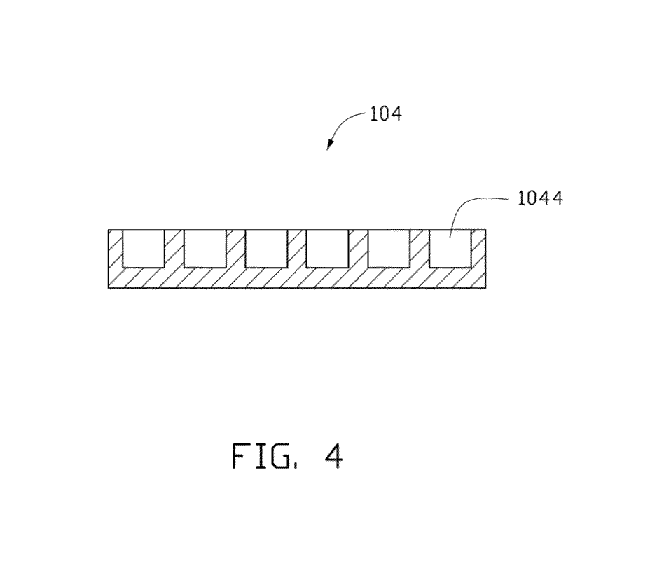

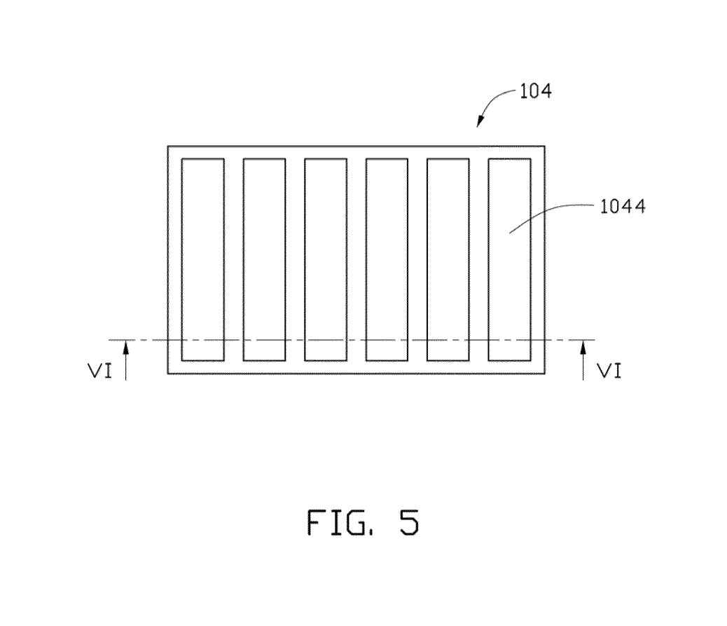

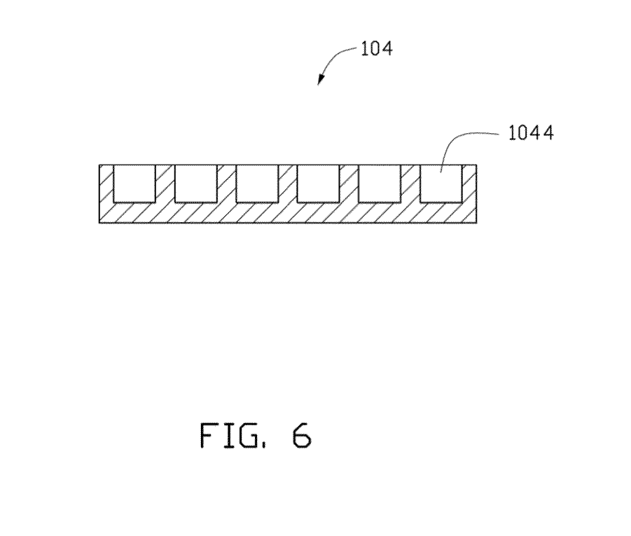

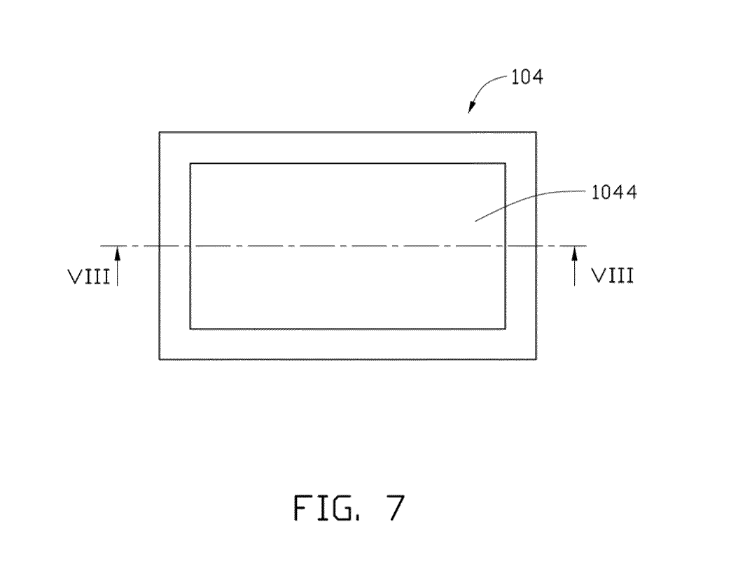

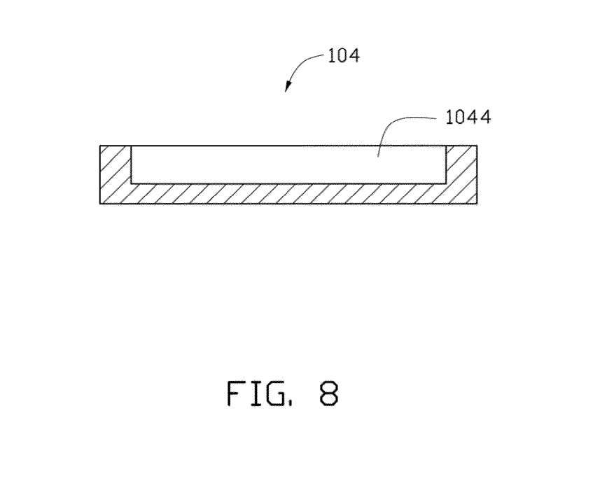

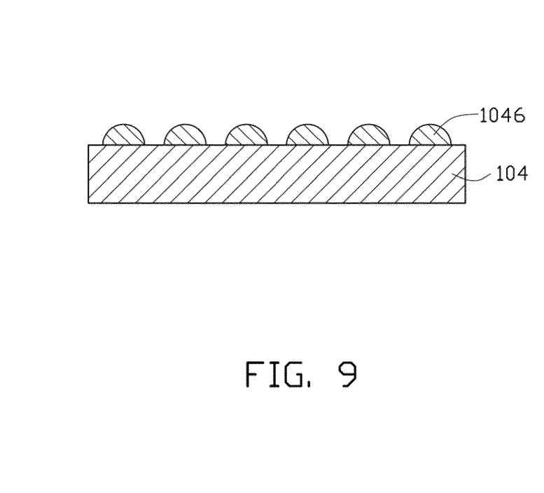

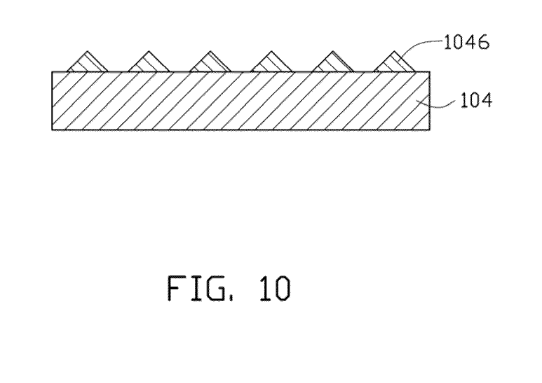

The heat insulated sheet 104 includes a top surface (not labeled), with the heating element 106 disposed on the top surface. The top surface can be a plane surface. In other embodiments, the top surface can be a geometrical surface, and the heat insulated sheet 104 can include at least one groove or protrusion. The groove can be a blind hole or through hole. And the cross sectional surface of the groove or the protrusion can be round, square, triangular or other irregular shapes. For example, referring to FIGS. 3 and 4, the heat insulated sheet 104 can include a plurality of columnar blind holes 1044a. Referring to FIGS. 5 and 6, the heat insulated sheet 104 can include a plurality of bar-shaped grooves 1044b. Referring to FIGS. 7 and 8, the heat insulated sheet 104 can include one square groove 1044c. Referring to FIG. 9, the heat insulated sheet 104 can include a plurality of half-sphere protrusions 1046a; and referring to FIG. 10, the heat insulated sheet 104 can include a plurality of V-shaped rises 1046b. At least a portion of the heating element 106 is hung in the air via the groove 1044a, 1044b, 1044c or the protrusion 1046a, 1046b of the heat insulated sheet 104. In addition, the contacting surface between the heating element 106 and the heat insulated sheet 104 can be decreased via the rise or the groove, the heat transfer between the heating element 106 and the heat insulated sheet 104 will be decreased. As such, the wall mounted heater 100 has a high efficiency.

The heating element 106 can be a carbon nanotube layer structure. The carbon nanotube layer structure can be a free-standing structure, that is, the carbon nanotube layer structure can be supported by itself. For example, when someone is holding at least a point of the carbon nanotube layer structure, the entire carbon nanotube layer structure can be lifted without being destroyed. The carbon nanotube layer structure includes a plurality of carbon nanotubes joined by van der Waals attractive force therebetween. The carbon nanotube layer structure can be a substantially pure structure of the carbon nanotubes, with few impurities. The carbon nanotubes can be used to form many different structures and provide a large specific surface area. The heat capacity per unit area of the carbon nanotube layer structure can be less than 2×10⁻⁴ J/m²*K. In one embodiment, the heat capacity per unit area of the carbon nanotube layer structure is less than or equal to 1.7×10⁻⁶ J/m²*K. Because the heat capacity of the carbon nanotube layer structure is very low, and the temperature of the heating element 106 can rise and fall quickly, the heating element 106 has a high heating efficiency and accuracy. Because the carbon nanotube layer structure can be substantially pure, the carbon nanotubes are not easily oxidized and the lifespan of the heating element 106 will be relatively longer. Furthermore, the carbon nanotubes have a low density, about 1.35 g/cm³, so the heating element 106 is light. Because the heat capacity of the carbon nanotube layer structure is very low, the heating element 106 has a high heating response speed. The carbon nanotube layer structure with a plurality of carbon nanotubes has a large specific surface area. If the specific surface of the carbon nanotube layer structure is large enough, the carbon nanotube layer structure is adhesive and can be directly applied to a surface.

The carbon nanotubes in the carbon nanotube layer structure can be orderly or disorderly arranged. The term ‘disordered carbon nanotube layer structure’ refers to a structure where the carbon nanotubes are arranged along different directions, and the aligning directions of the carbon nanotubes are random. The number of the carbon nanotubes arranged along each different direction can be almost the same (e.g. uniformly disordered). The disordered carbon nanotube layer structure can be isotropic, namely the carbon nanotube film has substantially identical properties in all directions of the carbon nanotube film. The carbon nanotubes in the disordered carbon nanotube layer structure can be entangled with each other.

The carbon nanotube layer structure including ordered carbon nanotubes is an ordered carbon nanotube layer structure. The term ‘ordered carbon nanotube layer structure’ refers to a structure where the carbon nanotubes are arranged in a consistently systematic manner, e.g., the carbon nanotubes are arranged approximately along a same direction and/or have two or more sections within each of which the carbon nanotubes are arranged approximately along a same direction (different sections can have different directions). The carbon nanotubes in the carbon nanotube layer structure 164 can be selected from single-walled, double-walled, and/or multi-walled carbon nanotubes.

The carbon nanotube layer structure can be a film structure with a thickness ranging from about 0.5 nanometers (nm) to about 1 mm. The carbon nanotube layer structure can include at least one carbon nanotube film.

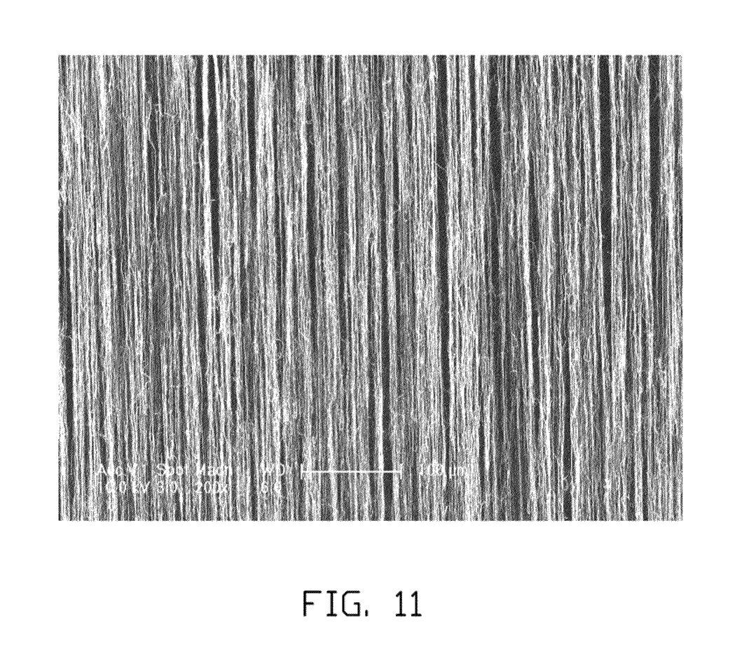

In one embodiment, the carbon nanotube film is a drawn carbon nanotube film. A film can be drawn from a carbon nanotube array, to obtain a drawn carbon nanotube film. The drawn carbon nanotube film includes a plurality of successive and oriented carbon nanotubes joined end-to-end by van der Waals attractive force therebetween. The drawn carbon nanotube film is a free-standing film. Referring to FIG. 11, each drawn carbon nanotube film includes a plurality of successively oriented carbon nanotube segments joined end-to-end by van der Waals attractive force therebetween. Each carbon nanotube segment includes a plurality of carbon nanotubes substantially parallel to each other, and joined by van der Waals attractive force therebetween. As can be seen in FIG. 11, some variations can occur in the drawn carbon nanotube film. The carbon nanotubes in the drawn carbon nanotube film are oriented along a preferred orientation. The carbon nanotube film can be treated with an organic solvent to increase the mechanical strength and toughness of the carbon nanotube film and reduce the coefficient of friction of the carbon nanotube film. The thickness of the carbon nanotube film can range from about 0.5 nm to about 100 μm.

The carbon nanotube layer structure of the heating element 106 can include at least two stacked carbon nanotube films. In other embodiments, the carbon nanotube layer structure can include two or more coplanar carbon nanotube films, and can include layers of coplanar carbon nanotube films. Additionally, when the carbon nanotubes in the carbon nanotube film are aligned along one preferred orientation (e.g., the drawn carbon nanotube film), an angle can exist between the orientations of carbon nanotubes in adjacent films, whether stacked or adjacent. Adjacent carbon nanotube films can be joined by van der Waals attractive force therebetween. The number of the layers of the carbon nanotube films is not limited. However, the thicker the carbon nanotube layer structure, the smaller the specific surface area. An angle between the aligned directions of the carbon nanotubes in two adjacent carbon nanotube films can range from about 0 degrees to about 90 degrees. If the angle between the aligned directions of the carbon nanotubes in adjacent carbon nanotube films is larger than 0 degrees, a microporous structure is defined by the carbon nanotubes in the heating element 106. The carbon nanotube layer structure employing these films will have a plurality of micropores. Stacking the carbon nanotube films will also add to the structural integrity of the carbon nanotube layer structure.

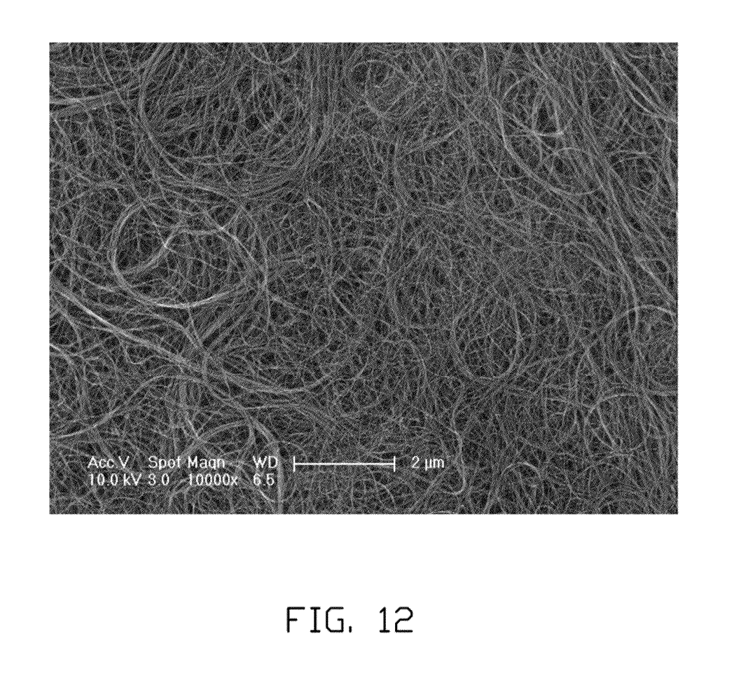

In other embodiments, the carbon nanotube film can be a flocculated carbon nanotube film. Referring to FIG. 12, the flocculated carbon nanotube film can include a plurality of long, curved, disordered carbon nanotubes entangled with each other. Further, the flocculated carbon nanotube film can be isotropic. The carbon nanotubes can be substantially uniformly dispersed in the carbon nanotube film. Adjacent carbon nanotubes are acted upon by van der Waals attractive force to obtain an entangled structure with micropores defined therein. It is understood that the flocculated carbon nanotube film is very porous. Sizes of the micropores can be less than 10 μm. The porous nature of the flocculated carbon nanotube film will increase the specific surface area of the carbon nanotube layer structure. Further, because the carbon nanotubes in the carbon nanotube layer structure are entangled with each other, the carbon nanotube layer structure employing the flocculated carbon nanotube film has excellent durability, and can be fashioned into desired shapes with a low risk to the integrity of the carbon nanotube layer structure. The thickness of the flocculated carbon nanotube film can range from about 0.5 nm to about 1 mm.

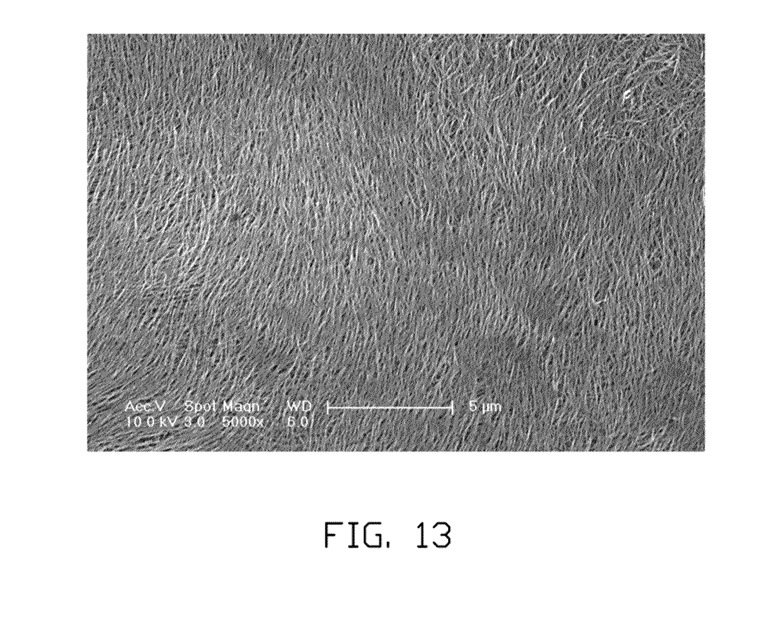

In other embodiments, the carbon nanotube film can be a pressed carbon nanotube film. Referring to FIG. 13, the pressed carbon nanotube film can be a free-standing carbon nanotube film. The carbon nanotubes in the pressed carbon nanotube film are arranged along a same direction or along different directions. The carbon nanotubes in the pressed carbon nanotube film can rest upon each other. Adjacent carbon nanotubes are attracted to each other and joined by van der Waals attractive force. An angle between a primary alignment direction of the carbon nanotubes and a surface of the pressed carbon nanotube film is about 0 degrees to approximately 15 degrees. The greater the pressure applied, the smaller the angle obtained. When the carbon nanotubes in the pressed carbon nanotube film are arranged along different directions, the carbon nanotube layer structure can be isotropic. Here, “isotropic” means the carbon nanotube film has properties substantially identical in all directions parallel to a surface of the carbon nanotube film. The thickness of the pressed carbon nanotube film ranges from about 0.5 nm to about 1 mm.

The two electrodes 108 can be disposed or fixed on a top surface of the heating element 106 by conductive adhesive (not shown). The two electrodes 108 are made of conductive material. The shapes of the two electrodes 108 are not limited and can be lamellar-shape, rod-shape, wire-shape, and block-shape, for example. The cross sectional shape of the two electrodes 108 can be round, square, trapezium, triangular or polygonal. The thickness of the two electrodes 108 can vary, depending on the design, and can be about 1 micrometer to about 1 centimeter. The two electrodes 108 are electrically connected with the source wire 120 at the source connection, and the source wire 120 is electrically connected with the source plug 124. In the present embodiment, as shown in FIG. 1, two electrodes 108 both have a linear shape, and are disposed on the top surface of the heating element 106. The two electrodes 108 are substantially parallel with each other. In one embodiment, when the heating element 106 includes the carbon nanotube layer structure having a plurality of carbon nanotubes arranged in a same direction, the axes of the carbon nanotubes can be substantially perpendicular with the two electrodes 108.

A material of the enclosure 110 can be selected from the group consisting of metal, metal alloy, plastic and wood. The enclosure 110 can fix the substrate 102, the heat insulated sheet 104 and the heat element 106 therein via screw, buckle or adhesive. In one embodiment, according to FIG. 1, the enclosure 110 includes a pair of first side columns 1102 and a pair of second columns 1104. The pair of first side columns 1102 faces each other. The pair of second side columns 1104 faces each other. A square hollow space is defined between the pair of first side columns 1102 and the pair of second side columns 1104. A cross sectional surface of the enclosure 110 is L-shaped, and an L-shaped groove is defined by the enclosure 110. The substrate 102, the heat insulated sheet 104 and the heat element 106 are disposed on the L-shaped groove. In the present embodiment as shown in FIGS. 1 and 2, the substrate 102, the heat insulated sheet 104, the heat element 106 and the two electrodes 108 are fixed in the enclosure 110 via adhesive (not shown).

In use, when a voltage is applied to the two electrodes 108 of the wall mounted electric heater 100, the carbon nanotube layer structure of the heating element 106 radiates heat at a certain wavelength. By controlling the specific surface area of the carbon nanotube layer structure, and selecting the voltage and the thickness of the carbon nanotube layer structure, the heating element 106 can emit heat at different wavelengths. If the voltage is at a certain determined value, the wavelength of the electromagnetic waves emitted from the carbon nanotube layer structure is inversely proportional to the thickness of the carbon nanotube layer structure. That is to say, the greater the thickness of carbon nanotube layer structure is, the shorter the wavelength of the electromagnetic waves. Furthermore, if the thickness of the carbon nanotube layer structure is determined at a certain value, the greater the voltage applied to the electrodes 108, and the shorter the wavelength of the electromagnetic waves. As such, the wall mounted electric heater 100 can be easily controlled to emit a visible light and create general thermal radiation or emit infrared radiation. The wall mounted electric heater 100 can also be used as a light source. The carbon nanotube layer structure has good flexibility, when other elements of the wall mounted electric heater 100 are made of flexible materials, the wall mounted electric heater 100 can be flexible and the shape of the wall mounted electric heater 100 can be fixed according to the wall shape.

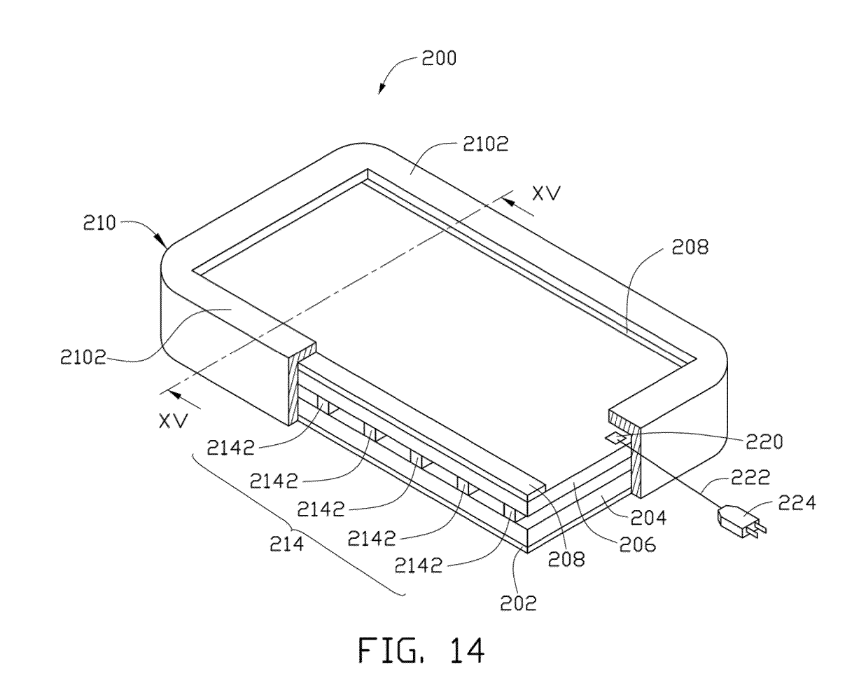

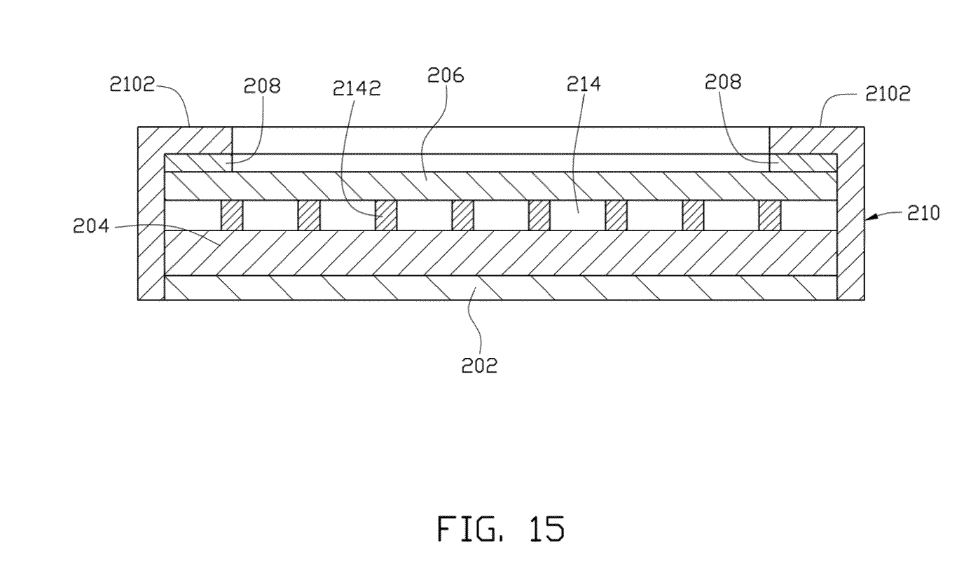

Referring to FIGS. 14 and 15, another embodiment of a wall mounted electric heater 200 includes a substrate 202, a heat insulated sheet 204, a heating element 206, at least two electrodes 208 and an enclosure 210. The substrate 202, the heat insulated sheet 204 and the heating element 206 form a multilayer structure in that order. The multilayer structure, comprised of the substrate 202, the heat insulated sheet 204 and the heating element 206, is fixed by the enclosure 210. The wall mounted electric heater 200 further includes a source connection 220, a source wire 222 and a source plug 224.

The wall mounted electric heater 200 further includes a spacer layer 214 disposed between the heat insulated sheet 204 and the heating element 206. The spacer layer 214 suspends the heating element 206 on the heat insulated sheet 204 so that the wall mounted electric heater 200 has high heating efficiency. The spacer layer 214 includes a plurality of spacers 2142, and heights of the spacers 2142 are uniform. The plurality of spacers 2142 can be disposed uniformly or randomly. The shapes of the spacers 2142 are not limited, and can be sphere, tetrahedron, column, cube, or cone shaped. The spacers 2142 and the heating element 206 can have a linear contact or a point contact to increase the suspended area of the heating element 206. A material of the spacer 2142 can be a conductive material such as metals, conductive adhesives, and indium tin oxides, for example. The material of the spacer 2142 can also be insulating materials such as glass, ceramic, or resin. In the present embodiment according to FIG. 15, each of the spacers 2142 has a cuboid shape.

The other features of the wall mounted electric heater 200 are similar to the wall mounted electric heater 100 as disclosed above.

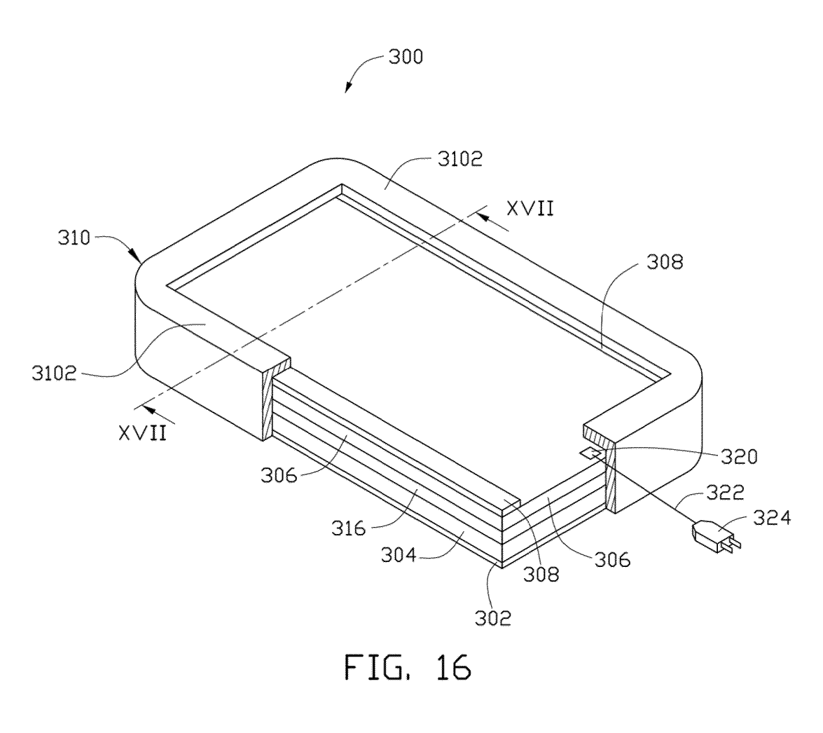

Referring to FIG. 16, a wall mounted electric heater 300 according to another embodiment is provided. The wall mounted electric heater 300 includes a substrate 302, a heat insulated sheet 304, a heating element 306, at least two electrodes 308 and an enclosure 310. The substrate 302, the heat insulated sheet 304 and the heating element 306 are assembled in a multilayer structure. The multilayer structure, comprised of the substrate 302, the heat insulated sheet 304 and the heating element 306, is fixed by the enclosure 310. The wall mounted electric heater 300 further includes a source connection 320, a source wire 322 and a source plug 324.

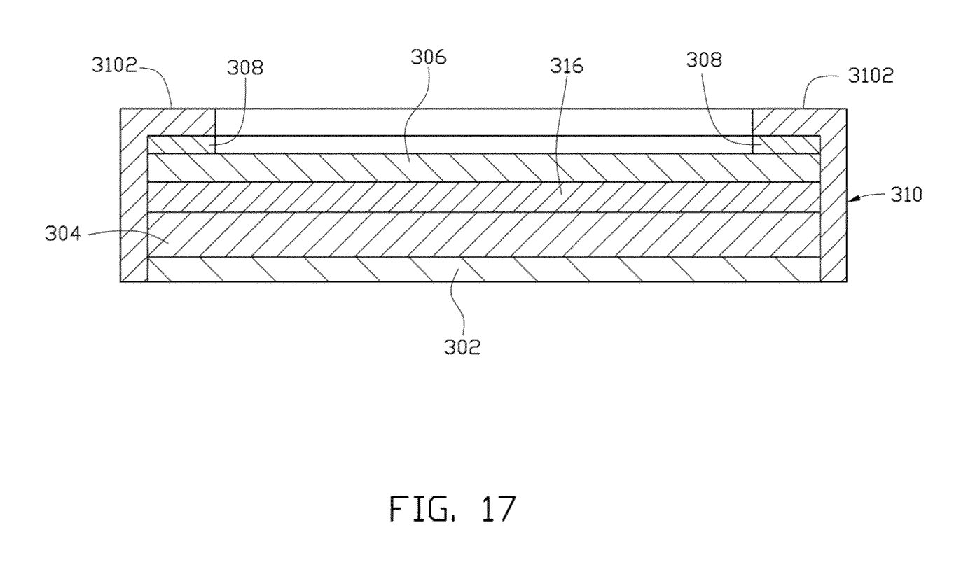

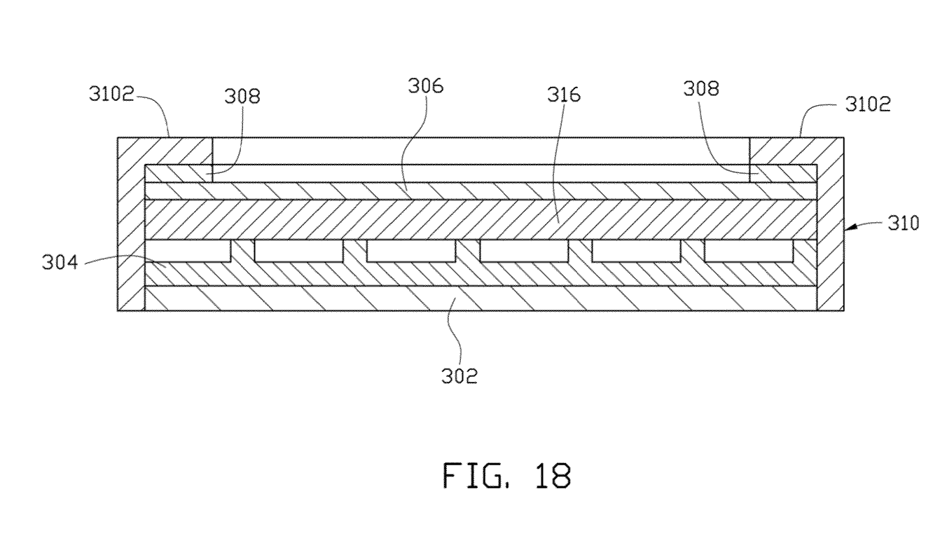

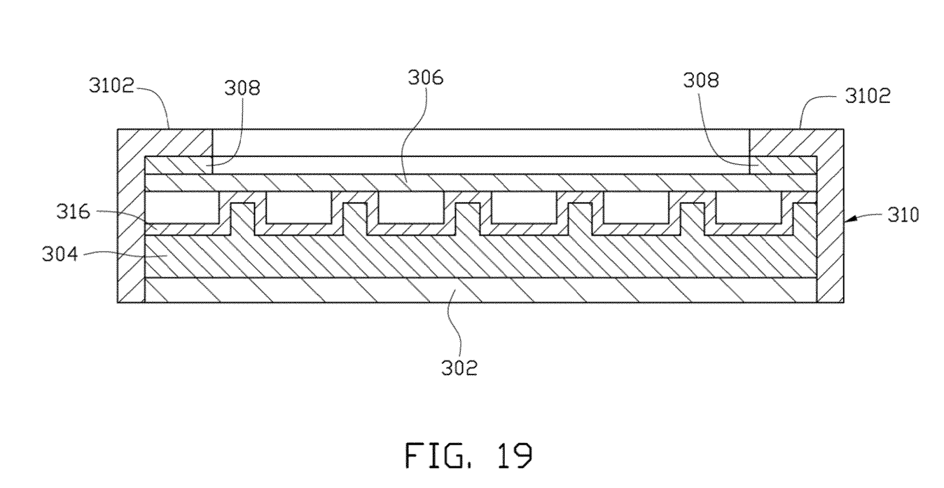

The wall mounted electric heater 300 further includes a heat-reflective layer 316 disposed between the heat insulated sheet 304 and the heating element 306. The heat-reflective layer 316 is configured to reflect back the heat emitted by the heating element 306, and configured for controlling the direction of the heat emitted by the heating element 306 for single-side heating. The material of the heat-reflective layer 316 can be conductive or insulative. The insulated materials can be metal oxides, metal salts, or ceramics. In one embodiment according to FIG. 17, the heat-reflective layer 316 is an aluminum oxide (Al₂O₃) film. The heat-reflective layer 316 is sandwiched between the heat insulated sheet 304 and the heating element 306. The thickness of the heat-reflective layer 316 can be in a range from about 100 micrometers (μm) to about 0.5 mm. In other embodiments, the heat insulated sheet 304 includes a geometrical surface. And the heat reflecting layer 306 can be suspended on the heat insulated sheet 304 as shown in FIG. 18 or can fit the geometrical surface as shown in FIG. 19.

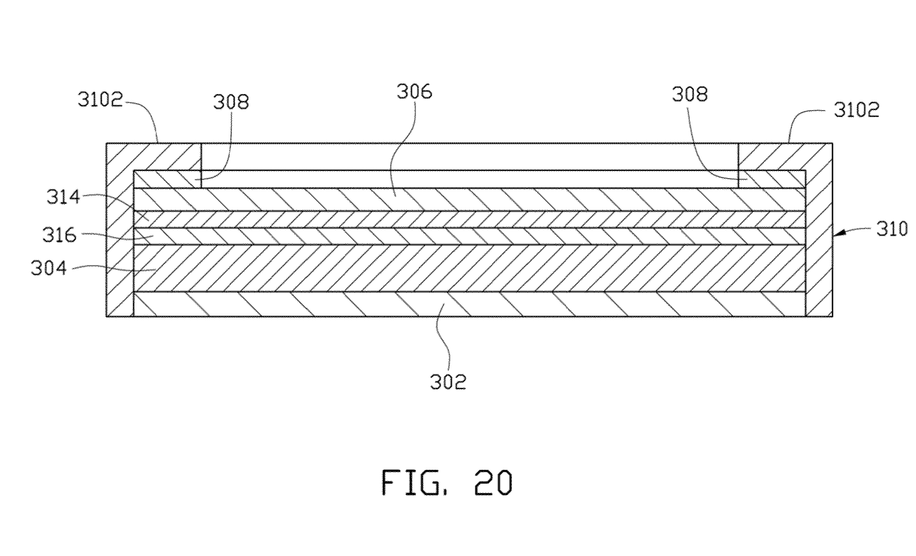

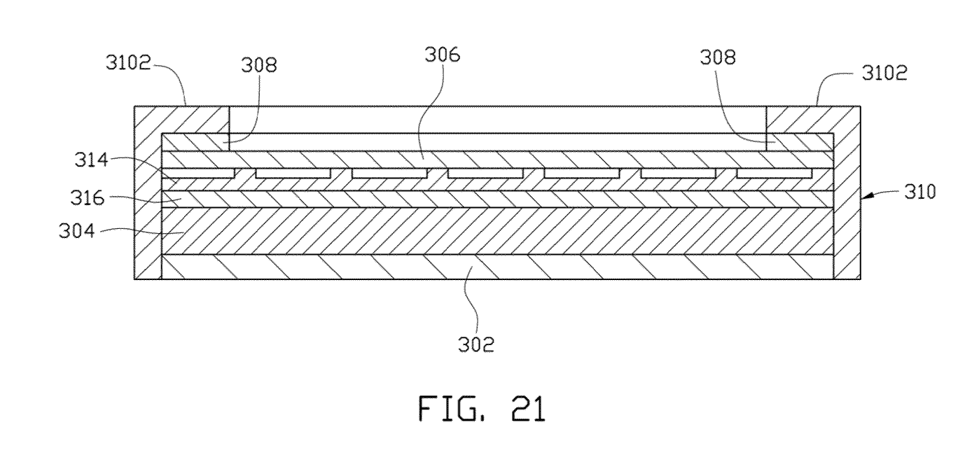

In another embodiment, when the heat-reflective layer 316 is made of conductive materials, such as silver, aluminum, gold or alloy, an insulated layer 314 is disposed between the heat-reflective layer 316 and the heating element 306 as shown in FIG. 20. The material of the insulated layer 316 can be ceramic, glass or plastic. A thickness of the insulated layer 314 can be in a range from about 1 micrometer to 1 millimeter. Referring to FIG. 21, a surface of the insulated layer 314 can be and includes a plurality of grooves or protrusions. The structure of the grooves or protrusions can be the same as the grooves or protrusions on the heat insulated sheet 104 disclosed above.

The wall mounted electric heater 300 having the heat-reflective layer 316 can emit heat in one direction. As the wall mounted electric heater 300 will be attached on the wall when used, the heat-reflective layer 316 can reflect the heat produced by the heating element 306 away from the wall, thus protecting the wall from damage by the heat. The efficiency of the wall mounted electric heater 300 will also be improved.

Other features of the wall mounted electric heater 300 are similar to the wall mounted electric heater 100 disclosed above.

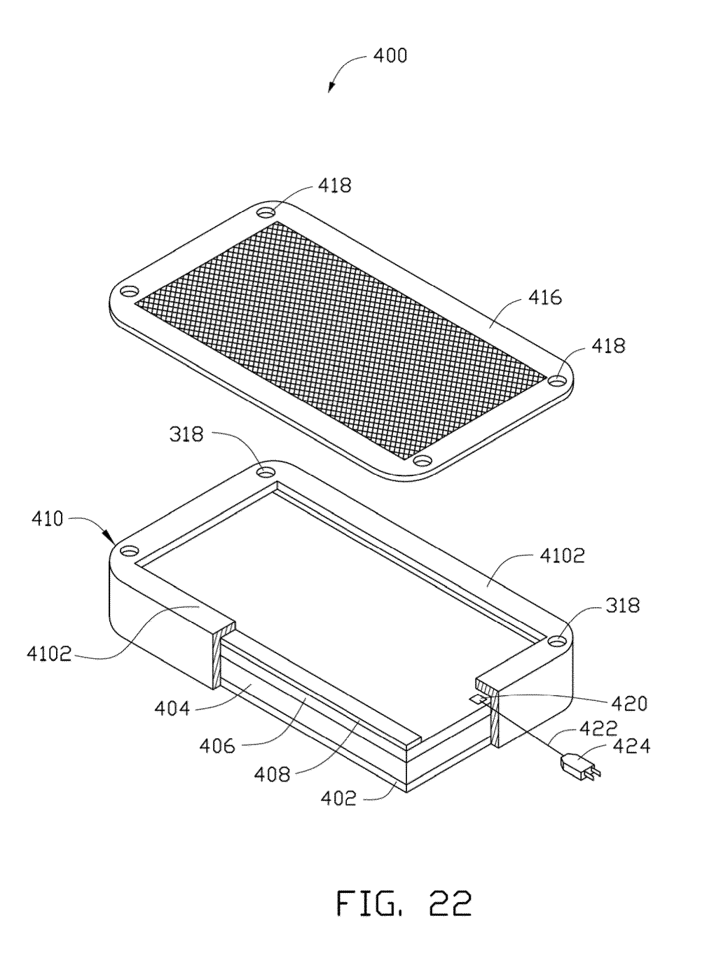

Referring to FIG. 22, a wall mounted electric heater 400 according to another embodiment is provided. The wall mounted electric heater 400 includes a substrate 402, a heat insulated sheet 404, a heating element 406, at least two electrodes 408 and an enclosure 410. The substrate 402, the heat insulated sheet 404 and the heating element 406 are assemble in a multilayer structure in that order. The multilayer structure, comprised of the substrate 402, the heat insulated sheet 404 and the heating element 406, is fixed in the enclosure 410. The wall mounted electric heater 400 further includes a source connection 420, a source wire 422 and a source plug 424.

The wall mounted electric heater 400 further includes a protecting structure 416 covering the heating element 406. The protecting structure 416 is configured for keeping the heating element 406 away from pollution and contaminants in the surroundings, and can also protect the user from getting an electric shock when touching the wall mounted electric heater 400. The material of protecting structure 416 can be conductive or insulated. The electrically conductive material can be metal or an alloy. The metal can be copper, aluminum or titanium. The insulated material can be resin, ceramic, plastic, or wood. The thickness of the protecting structure 416 can range from about 0.5 μm to about 2 mm. If the material of the protecting structure 416 is insulated, the protecting structure 416 can be directly disposed on a surface of the heating element 406. If the protecting structure 416 is conductive, the protecting structure 416 should be insulated with the heating element 406. The protecting structure 416 can be disposed above the heating element 406 and apart from the heating element 406. The protecting structure 416 can include a plurality of holes, such as a grid. According to one embodiment as shown in FIG. 22, the protecting structure 416 is a frame with a plurality of holes. The edges of the protecting structure 416 are fixed on the edges of the enclosure 410 via four screws 418. The protecting structure 416 is kept a distance from the heating element 406.

Other features of the wall mounted electric heater 400 are similar to the wall mounted electric heater 100 disclosed above.

It is to be understood that the above-described embodiments are intended to illustrate rather than limit the disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What is claimed is:

1. A wall mounted electric heater comprising:
a substrate having a substrate surface;
a heat insulated sheet disposed on the substrate surface, and the heat insulated sheet having a heat insulated sheet surface and at least one groove or protrusion located at the heat insulated sheet surface;
a heating element, disposed on the heat insulated sheet, comprising a carbon nanotube layer structure, and the heat insulated sheet being disposed between the substrate and the heating element;
at least two electrodes electrically connected with the heating element; and
an enclosure fixing the substrate, the heat insulated sheet, and the heating element therein.

2. The wall mounted electric heater of claim 1, wherein a heat capacity per unit area of the carbon nanotube layer structure is less than or equal to about 2×10⁻⁴ J/cm²*K.

3. The wall mounted electric heater of claim 1, wherein the carbon nanotube layer structure comprises at least one carbon nanotube film comprising a plurality of carbon nanotubes substantially parallel with each other.

4. The wall mounted electric heater of claim 3, wherein the plurality of carbon nanotubes in the carbon nanotube film form a plurality of carbon nanotube segments joined end-to-end, and the carbon nanotubes in each of the plurality of carbon nanotube segments are disposed side by side.

5. The wall mounted electric heater of claim 3, wherein the plurality of carbon nanotubes in the carbon nanotube film are substantially perpendicular with the at least two electrodes.

6. The wall mounted electric heater of claim 1, wherein the heat insulated sheet defines the at least one groove, and the at least one groove comprises a plurality of blind holes.

7. The wall mounted electric heater of claim 1, wherein the carbon nanotube layer structure is suspended on the heat insulated sheet via the at least one groove or protrusion.

8. The wall mounted electric heater of claim 1 further comprising a heat-reflective layer disposed between the heat insulated sheet and the heating element.

9. The wall mounted electric heater of claim 8, wherein the heat-reflective layer comprises an insulative material, and the heating element is disposed on a surface of the heat-reflective layer.

10. The wall mounted electric heater of claim 8 further comprising an insulated layer disposed between the heat-reflective layer and the heating element.

11. The wall mounted electric heater of claim 10, wherein a surface of the insulated layer is geometrical and the insulated layer comprises a plurality of grooves or protrusions at the surface.

12. The wall mounted electric heater of claim 1 further comprising a plurality of spacers disposed between the heat insulated sheet and the heating element.

13. The wall mounted electric heater of claim 1 further comprising a protecting structure covering the heating element.

14. The wall mounted electric heater of claim 13, wherein the protecting structure is a grid defining a plurality of holes.

15. The wall mounted electric heater of claim 1, wherein the enclosure is a frame structure comprising a pair of first side columns and a pair of second columns, the pair of first side columns faces each other, the pair of second side columns faces each other.

16. The wall mounted electric heater of claim 15, wherein a cross sectional surface of any one of the pair of first side columns and the pair of second columns is L-shaped; the border of the substrate, the border of the heat insulated sheet, the border of the heating element, and the at least two electrodes are disposed in the pair of first side columns and the pair of second columns.

17. A wall mounted electric heater comprising:
a substrate having a substrate surface;
a heat insulated sheet disposed on the substrate surface, and the heat insulated sheet having a geometrical surface with at least one groove or protrusion;
a heating element, disposed on the geometrical surface of the heat insulated sheet, comprising a free-standing carbon nanotube layer structure, and the heating element disposed between the substrate and the heating element;
at least two electrodes electrically connected with the heating element; and
an enclosure fixing the substrate, the heat insulated sheet, and the heating element therein.

18. The wall mounted electric heater of claim 17, wherein at least a part of the free-standing carbon nanotube layer structure is suspended via the geometrical surface of the heat insulated sheet.

19. A wall mounted electric heater comprising:
a substrate having a substrate surface;
a heat insulated sheet disposed on the substrate surface, the heat insulated sheet having a geometrical surface, and the heat insulated sheet comprising at least one groove or protrusion at the geometrical surface;
a heat-reflective layer disposed on the geometrical surface of the heat insulated sheet;
an insulated layer disposed on a surface of the heat-reflective layer;
a heating element, disposed on the insulated layer, comprising a free-standing carbon nanotube layer structure, wherein at least a part of the heating element is suspended via the insulated layer;
at least two electrodes electrically connected with the heating element; and
an enclosure fixing the substrate, the heat insulated sheet and the heating element therein.
